(19) United States
(12) Patent Application Publication
(10) Pub. No.: US 2019/0234775 A1
(43) Pub. Date: Aug. 1, 2019

(54) FLUID SENSING DEVICE

(71) Applicant: Guangzhou Seagull Kitchen and Bath Products Co., Ltd., Guangdong (CN)

(72) Inventors: Shuqi Gao, Guangdong (CN); Qianfeng Peng, Guangdong (CN); Rongbao Wei, Guangdong (CN); Fu Luo, Guangdong (CN)

(73) Assignee: Guangzhou Seagull Kitchen and Bath Products Co., Ltd., Guangdong (CN)

(21) Appl. No.: 15/941,008

(22) Filed: Mar. 30, 2018

(30) Foreign Application Priority Data
Jan. 31, 2018 (CN) 201810095349.6
Jan. 31, 2018 (CN) 201820163762.7

(51) Int. Cl. G01F 1/24

(52) U.S. Cl. CPC G01F 1/24

(57) ABSTRACT

The invention discloses a fluid sensing device provided in a flow path through which fluid flows, including a base fixed in the flow path; a piston core rod disposed in the base and connected to the base through an elastic member, the piston core rod being provided with a pushing surface pushed by the fluid in the flow path; a magnet provided on the piston core rod; a magnetic sensing device provided on a side surface of the piston core rod to sense change of magnetic line received as change of position of the magnet, thereby determining whether fluid flows in flow path; wherein the elastic member is disposed such that direction of the restoring force thereof is opposite to the direction of fluid flow in flow path. The present invention has fewer parts and easy production, and can reduce judgement difference caused by low flow rate.

### CROSS-REFERENCE TO RELATED APPLICATION

This application claims the priority benefit of China application serial no. 201810095349.6, filed on Jan. 31, 2018, and China application serial no. 201820163762.7, filed on Jan. 31, 2018. The entirety of each of the above-mentioned patent applications is hereby incorporated by reference herein and made a part of specification.

### BACKGROUND

### Technical Field of the Present Invention

The present invention relates to a sensing device, in particular to a fluid sensing device.

### Technical Background of the Present Invention

At present, commonly used fluid sensing devices generally have impeller blades. When fluid passes, the fluid flows through curved blades of the impeller blades, and the fluid exerts a force on the impeller blades to rotate the impeller blades. Some impeller blades itself have magnetism, one end of some impeller blades is connected to a magnetic block. When the impeller blades rotate, generated magnetic field is also changed. The magnetic sensing device determines whether the fluid in a flow path is flow status through sensing the change of the magnetic field.

Such technique has the following drawbacks: the material of the impeller blades with magnetism is special and expensive, and magnetic materials are involved in passing water and many related certifications are difficult to obtain. In addition, one end of the impeller blades is connected to the magnetic block, and there are more parts need a larger space. Generally, when the flow velocity of the fluid is small, the impeller blades do not rotate or the rotation speed is too slow, so the magnetic sensing device cannot sense the change of the magnetic field, resulting in a judgment difference or a judgment error.

### SUMMARY OF THE INVENTION

A purpose of the present invention is to provide a fluid sensing device, which determines whether the fluid passes through utilizing a change in a linear displacement of a magnet and detecting a change in a magnetic field by a magnetic probe or a magnetism sensing device.

Instead of utilizing the change of rotation of the magnet, the magnetic probe detecting the change of the magnetic field to determine whether the water fluid passes through.

In view of purposes mentioned above and other advantages, the present invention provides a mechanical fluid sensing device provided in a flow path through which fluid flows, comprising: a base fixed in the flow path; a piston core rod disposed in the base and connected to the base through an elastic member, the piston core rod being provided with a pushing surface pushed by a fluid in the flow path; a magnet provided on the piston core rod; a magnetic sensing device provided on a side surface of the piston core rod to sense a change of magnetic line received as a change of the position of the magnet, thereby determining whether a fluid flows in the flow path; wherein the elastic member is disposed such that the direction of the restoring force thereof is opposite to the direction of fluid flow in the flow path.

Preferably, the fluid sensing device also comprises: a pipe body which is fixed on the flow path along the flow direction of the fluid in the flow path, the pipe body being provided with a passage through which the fluid flows in the flow path, the base and the piston core rod being both located in the pipe body, the base being fixed on the pipe body and being fixed in the flow path by the pipe body, and the magnetic sensing device being arranged on the outer wall of the pipe body.

Preferably, in the fluid sensing device, the inner part of the base is hollow, and is communicated with the downstream end of the pipe body along fluid flow direction in the pipe body, the base being provided with a first through hole, the elastic member being located inside the base, and the elastic member being arranged to be compressed along the direction of the fluid flow in the pipe body, the piston core rod being disposed along the direction of the fluid flow in the pipe body and the upstream end thereof along the fluid flow direction in the pipe body passing through the first through hole and being located outside the base, inside the base, the piston core rod is connected to the base through a downstream end of the piston core rod along the fluid flow direction in the pipe body by the elastic member, the pushing surface being located on the upstream end of the piston core rod along the fluid flow direction in the pipe body, the upstream end of the piston core rod along the fluid flow direction in the pipe body being composed of a first part which can not pass through the first through hole and a second part which can pass through the first through hole along the fluid flow direction in the pipe body, and is in clearance fit with the first through hole.

Preferably, in the fluid sensing device, the first part and the second part are cylindrical shape arranged coaxially, the first part being in clearance fit with the pipe body, both the inside of the first part and the second part being hollow and communicating with each other, at least one first opening being disposed on the bottom surface of the first part away from the second part, each of the first openings communicating with the interior of the first part, and at least one second opening being disposed at a side wall of the second part, each of the second openings communicating with the interior of the second part, the second opening being configured such that the second opening is entirely located in the base when the first part moves along the fluid flow direction in the pipe body to abut the base, and the interior of the second part communicating with the interior of the base through the second opening.

Preferably, in the fluid sensing device, a second through hole is arranged on the base, the downstream end of the piston core rod along the fluid flow direction in the pipe body passing through the second through hole, and being composed of a third part and a fourth part, the third part being located in the base, the cross-sectional dimension of the third part being less than the cross-sectional dimension of the second part, the fourth part passing through the second through hole and being located outside the base, the second through hole being disposed so that the second through hole is in clearance fit with the third part when the piston core rod moves along the fluid flow direction, the elastic member being a spring, the piston core rod in the inner part of the base through the third part being connected with the base by the spring, the spring being sleeved on the third part, two ends of the spring abutting against the base and the second part, respectively.

Preferably, in the fluid sensing device, the third part is cylindrical shape, the fourth part being gradually increased in diameter toward the third part to be equal in diameter to the third part, the third part and the fourth part being disposed coaxially with the second part, respectively.

Preferably, in the fluid sensing device, the side wall of the fourth part is provided with a protrusion, the protrusion being arranged so that the protrusion abuts against the base when the third part is located in the base, a notch being provided on the fourth part along the axial direction of the fourth part, and running through the fourth part and extending into the third part, the notch being provided so that the fourth part and the protrusion can both pass through the second through hole when the notch is tightened.

Preferably, in the fluid sensing device, the base has two bottom surfaces parallel to each other, the base being seamlessly connected or in clearance fit with the inner wall of the pipe body through the side wall of the base, the first through hole and the second through hole being respectively located on two bottom surfaces of the base, the bottom surface of the base provided with the second through hole being provided with at least one third opening, and the interior of the base being communicated with the downstream end of the pipe body along the fluid flow direction in the pipe body through the third opening.

Preferably, in the fluid sensing device, specific manner that the base is fixed on the pipe body is as follows: the upstream end and the downstream end of the pipe body along the fluid flow direction therein are both internally hollow cylindrical shape and arranged coaxially, the inner diameter of the upstream end of the pipe body along the fluid flow direction therein being greater than the inner diameter of the downstream end of the pipe body along the fluid flow direction therein, the base being stuck on the upstream end of the pipe body along the fluid flow direction therein, and being seamlessly connected with the upstream end of the pipe body along the fluid flow direction therein, and the bottom surface of the base provided with the second through hole being provided on the downstream end of the pipe body along the fluid flow direction therein, the downstream end of the pipe body along the fluid flow direction therein doing not seal the third opening.

Preferably, in the fluid sensing device, the second opening and the third opening are equal in number and are multiple in number, and the second openings being spaced apart along the circumferential direction of the second part, the second opening and the third opening being relative one by one when the second opening is located in the base.

Preferably, in the fluid sensing device, the base comprises an integral upper part and a lower part, the upper part and the lower part of the base being both internally hollow cylindrical and being communicated with each other and coaxially arranged with the pipe body, the first through hole being arranged on a bottom surface of the upper part of the base, the second through hole being provided on a bottom surface of the lower part of the base, the second part and the third part each having an outer diameter smaller than the inner diameter of the upper part and the lower part of the base, the outer side wall of the lower part of the base being not in contact with the inner wall of the pipe body, The inner diameter of the downstream end of the pipe body along the fluid flow direction therein being smaller than the outer diameter of the lower part of the base and larger than the inner diameter of the lower part of the base, a plurality of fourth openings being arranged alternately at the side wall of the lower part of the base in the circumferential direction, the numbers of the fourth opening and the third opening being equal and corresponding one to one, the third openings being arranged alternately along the edge of a bottom surface of the lower part of the base, fourth openings penetrating through the side wall of the lower part of the base and communicating with the corresponding third openings, and the plurality of fourth openings being arranged such that the second openings are opposite to the fourth openings one by one when the second openings are located in the base, and the base through the upper part thereof being hermetically connected with the upstream end of the pipe body along the fluid flow direction therein.

Preferably, in the fluid sensing device, the magnet is embedded and sealed on the piston core rod.

Preferably, in the fluid sensing device, the second opening is elongated shape and runs through the side wall of the second part along the length of the second part.

Preferably, in the fluid sensing device, the base is provided with a pressure relief hole which is respectively communicated with the upstream end of the pipe body along the fluid flow direction therein and the inside of the base.

Preferably, in the fluid sensing device, the specific manner that the base is fixed on the pipe body is as follows: the pipe body and the base are both internally hollow cylindrical shape and arranged coaxially, a gap being arranged between the outer side wall of the base and the inner side wall of the pipe body, a plurality of supporting blocks being alternately arranged on the inner side wall of the pipe body along the circumferential direction, the bottom surface of the base provided with the second through holes is laid on plurality of supporting blocks, supporting blocks doing not seal the third opening, the inner side wall of the pipe body and the outer side wall of the base being alternately provided with a plurality of connecting rods in the circumferential direction of the base, one end of each connecting rod being fixedly connected with the inner side of the pipe body, and the other end abutting against the outer side wall of the base.

Preferably, in the fluid sensing device, the third part is composed of two rod bodies, the middle part of one of the two rod bodies protruding with a cylinder-shaped connecting part, and the middle part of the other of the two rod bodies concaving with a circular hole channel, the connecting part being inserted in the circular hole channel, the connecting part and the inner wall of the circular hole channel formed on the piston core rod being threaded connection.

Preferably, the fluid sensing device also comprises: a vertical rod fixed on the side wall of the fourth part and parallel to the axis of the fourth part, the vertical rod capable of passing through the second through hole when the notch is tightened; a support rod which is arranged in the downstream end of the pipe body along the fluid flow direction therein and being fixedly connected with the inner side wall of the pipe body, the support rod being provided with a third through hole, the vertical rod passing through the third through hole, the first opening being entirely located in the base when the fourth part is laid on the support rod.

The present invention includes at least the following advantages:

1. Fewer parts and easy production.

2. The magnet is embedded in the piston core rod, and more space-saving.

3. The magnet is sealed inside the piston core rod and solves the certification and expense problems caused by the magnet over water.

4. The fluid sensing device can reduce judgement difference caused by low fluid flow rate.

Other advantages, objects, and features of the present invention will be showed in part through following description, and in part will be understood by those skilled in the art from study and practice of the present invention.

### BRIEF DESCRIPTION OF THE DRAWINGS

FIG. 1 is a structural view of the piston core rod according to one embodiment of the present invention;

FIG. 2 is a structural view of the base according to one embodiment of the present invention;

FIG. 3 is a cross-sectional view taken along line A-A in FIG. 1;

FIG. 4 is a cross-sectional view taken along line B-B in FIG. 2;

FIG. 5 is a structural view of the pipe body with no fluid passing through according to one embodiment of the present invention;

FIG. 6 is a structural view of the pipe body with fluid passing through according to one embodiment of the present invention;

FIG. 7 is a structural view of the third part according to one embodiment of the present invention;

FIG. 8 is structural views of the supporting block and the connecting rod according to one embodiment of the present invention;

FIG. 9 is a structural view of the supporting block according to one embodiment of the present invention;

FIG. 10 is structural views of the support rod according to one embodiment of the present invention.

### DETAILED DESCRIPTION

The present invention will now be described in further detail with reference to the accompanying drawings in order to enable person skilled in the art to practice with reference to the description.

It should be noted that in the description of the present invention, the terms of “transverse”, “longitudinal”, “up”, “down”, “front”, “back”, “left”, “right”, “vertical”, “horizontal”, “top”, “bottom”, “inner”, “outer” and the like are based on the orientation or positional relationship shown in the drawings for convenience of describing the present invention and simplifying description. It is not intended or implied that the device or element must have a particular orientation and be constructed and operated in a particular orientation, and therefore it should not be construed as limiting the present invention.

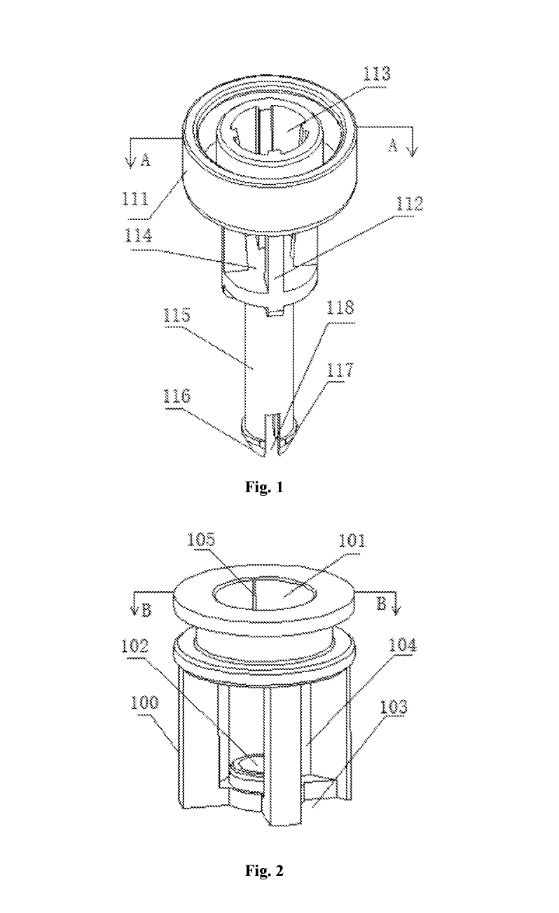

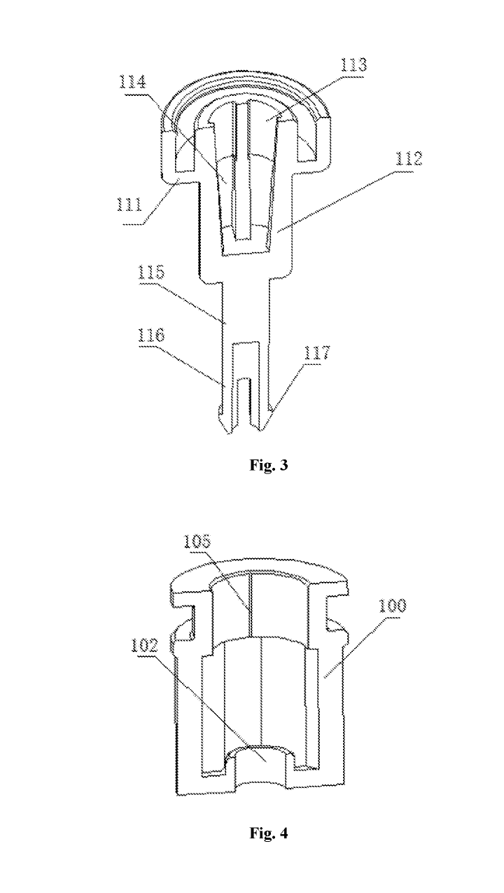

As shown in FIG. 1 to FIG. 10, the present invention provides a fluid sensing device provided in a flow path through which fluid flows, comprising: a base 100 fixed in the flow path; a piston core rod 110 disposed in the base 100 or on the base 100, and connected to the base 100 through an elastic member 120, the piston core rod 110 being provided with a pushing surface pushed by a fluid in the flow path. The elastic member 120 may be an elastic sheet, a rib, a spring, etc., preferably a spring with low cost and easy to control elastic deformation.

A magnet 130 provided on the piston core rod 110. The magnet 130 may be a soft magnet or a permanent magnet, preferably a permanent magnet with stable magnetism and hard to demagnetize.

A magnetic sensing device 190 or magnetic probe provided on a side surface of or around the piston core rod to sense a change of magnetic line or magnetic field strength received as a change of the position of the magnet 130, thereby determining whether a fluid flows in the flow path.

Wherein the elastic member 120 is disposed such that the direction of the restoring force thereof is opposite to the direction of fluid flow in the flow path.

The fluid sensing device provided in the solution, when the fluid flows in the flow path, such as a water flow or airflow, it will push the piston core rod 110 to move. The piston core rod 110 will drive the magnet 130 provided on thereof to move. The magnetic sensing device 190 can sense change of the magnetic field intensity, thereby determining whether a fluid flows in the flow path. When there is no fluid in the flow path, the elastic member 120 is returned and the piston core rod 110 is returned to the position before the fluid flows.

The solution utilizes displacement change of the magnet 130, and utilizes the magnetic probe or the magnetic sensing device 190 to detect the change of the magnetic field intensity, thereby determining whether a fluid flows in the flow path. In this embodiment, the magnetic sensing device 190 is disposed directly in the flow path through which the fluid flows.

In a preferred embodiment, the fluid sensing device further comprises: a pipe body 140 which is fixed on or in the flow path along the flow direction of the fluid in the flow path, the pipe body 140 being provided with a passage through which the fluid flows in the flow path, the base 100 and the piston core rod 110 being both located in the pipe body, the base 100 being fixed in the pipe body 140 and being fixed in the flow path by the pipe body 140, and the magnetic sensing device 190 being arranged on the outer wall of the pipe body 140.

In the above solution, the piston core rod 110 is fixed on the base 100, the base 100 is fixed in the pipe body 140, and then the pipe body 140 is fixed on the flow path or in the flow path, so that the fluid sensing device can be positioned on the flow path through which the fluid flows.

In a preferred embodiment, in the fluid sensing device, the inner part of the base 100 is hollow, and is communicated with the downstream end of the pipe body along fluid flow direction in the pipe body 140, Thus the fluid entering the base 100 can flow to the downstream end of the pipe body along fluid flow direction in the pipe body 140 and flow out through the downstream end of the pipe body along fluid flow direction in the pipe body 140. The base is provided with a first through hole 101, the elastic member 120 being located inside the base 100, and the elastic member 120 being arranged to be compressed along the direction of the fluid flow in the pipe body 140, the piston core rod 110 being disposed along the direction of the fluid flow in the pipe body 140 and the upstream end thereof along the fluid flow direction in the pipe body 140 passing through the first through hole 101 and being located outside the base 100. the piston core rod 110 through the downstream end thereof along the fluid flow direction in the pipe body 140 being connected to the base 100 by the elastic member 120 in the interior of the base 100, the pushing surface being located on the upstream end of the piston core rod 110 along the fluid flow direction in the pipe body 140. The upstream end of the piston core rod 110 along the fluid flow direction in the pipe body 140 is composed of a first part 111 which can not pass through the first through hole 101 and a second part 112 which can pass through the first through hole 101 along the fluid flow direction in the pipe body 140, and is in clearance fit with the first through hole 101. The first through hole 101 enables the upstream end of the pipe body 140 along the fluid flow direction therein to communicate with the interior of the base 100, because the interior of the base 100 communicates with the downstream end of the pipe body 140 along the fluid flow direction therein. In this way, when there is no fluid in the flow path, the upstream end of the pipe body 140 along the fluid flow direction in the pipe body 140 communicates with the downstream end of the pipe body 140 along the fluid flow direction therein, and the pressure in the pipe body 140 is uniform.

In the above solution, when the fluid in the pipe body 140 passes through, the fluid pushes the piston core rod 110 to move and drives the magnet 130 thereon to move. The magnetic sensing device 190 can sense the change of the magnetic field intensity to determine the fluid flow in the flow path. When the piston core rod 110 moves along the direction of fluid flow in the pipe body 140, the elastic member 120 is compressed while the second part 112 passes through the first through hole 101 and enters the base 100. When no fluid enters the pipe body 140, the elastic member 120 is returned and the second part 112 is pushed to the outside of the base 100. The first through hole 101 can guide the second part 112 during its movement. Because the first part 111 can not pass through the first through hole 101, the first part 111 will abut against the base 100 when flow velocity of the fluid in the pipe body 140 is relatively large, so that the elastic member 120 can be prevented from overcompression.

In a preferred embodiment, the fluid sensing device, as shown in FIG. 1, the first part 111 and the second part 112 are cylindrical shape arranged coaxially, the first part 111 being in clearance fit with the pipe body 140, both the inside of the first part 111 and the second part 112 being hollow and communicating with each other, at least one first opening 113 being disposed on the bottom surface of the first part 111 away from the second part 112, each of the first openings 113 communicating with the interior of the first part 111, and at least one second opening 114 being disposed at a side wall of the second part 112, each of the second openings 114 communicating with the interior of the second part 112, the second opening 114 being configured such that the second opening 114 is entirely located in the base 100 when the first part 111 moves along the fluid flow direction in the pipe body 140 to abut the base, and the interior of the second part 112 communicating with the interior of the base 100 through the second opening 114.

In the above solution, when the fluid in the pipe body 140 flows, the pressure of the upstream end of the pipe body 140 along the fluid flow direction therein increases and is greater than the pressure in the base 100 and the downstream end of the pipe body 140 along the fluid flow direction therein. The first through hole 101 can not transmit the pressure of the upstream end of the pipe body 140 along the fluid flow direction therein to the base 100 and of the downstream end of the pipe body 140 along the fluid flow direction therein, therefore, the pressure difference will be produced. When the pressure difference is greater than the elastic force of the elastic member 120, the fluid pushes the piston core rod 110 to move so that the second part 112 passes through the first through hole 101 while the fluid enters the first part 111 and the second part 112 through the first opening 113. When the second opening 114 enters the base 100, the interior of the second part 112 communicates with the interior of the base 100 through the second opening 114, and the fluid in the first part 111 and the second part 112 enters into the base 100 through the second opening 114. Because the interior of the base 100 is in communication with the downstream end of the pipe body 140 along the fluid flow direction therein, the fluid flowing to the interior of the base 100 flows out the downstream end of the pipe body 140 along the fluid flow direction therein. When the fluid in the pipe body 140 is flowing, the fluid pushes the piston core rod 110 to move and drives the magnet 130 of the piston core rod 110 to move. The magnetic sensing device 190 can sense the change of the magnetic field intensity to determine the fluid flow in the flow path. When no fluid enters the pipe body 140, the upstream end of the pipe body 140 along the fluid flow direction therein communicates with the downstream end of the pipe body 140 along the fluid flow direction therein, and the pressure in the pipe body 140 is uniform. The elastic member 120 extends and pushes the second part 112 to the outside of the base 100.

In a preferred embodiment, in the fluid sensing device, a second through hole 102 is arranged on the base 100, the downstream end of the piston core rod 110 along the fluid flow direction in the pipe body 140 passing through the second through hole 102, and the downstream end of the piston core rod 110 along the fluid flow direction in the pipe body 140 being composed of a third part 115 and a fourth part 116, the third part 115 being located in the base 100, the cross-sectional dimension of the third part 115 being less than the cross-sectional dimension of the second part 112, the fourth part 116 passing through the second through hole 102 and being located outside the base 100, the second through hole 102 being disposed so that the second through hole 102 is in clearance fit with the third part 115 when the piston core rod 110 moves along the fluid flow direction in the pipe body 140, the elastic member 120 being a spring, the piston core rod 110 through the third part 115 in the inner part of the base 100 being connected with the base 100 by the spring, the spring being sleeved on the third part 115, two ends of the spring abutting against the base 100 and the second part 112, respectively.

In the above solution, when the fluid in the pipe body 140 is flowing, the fluid pushes the piston core rod 110 to move and drives the magnet 130 of the piston core rod 110 to move. The magnetic sensing device 190 can sense the change of the magnetic field intensity to determine the fluid flow in the flow path. When the piston core rod 110 moves along the direction of the fluid flows in the pipe body 140, the spring is compressed while the second part 112 passes through the first through hole 101 and enters the base 100, and the third part 115 passes through the second through hole 102, and extends out of the base 100. When no fluid enters the pipe body 140, the elastic member 120 is returned and pushes the second part 112 to the outside of the base 100, and the third part 115 is pulled back to the inside of the base 100. The first through hole 101 and the second through hole 102 respectively can play a guiding role in the movement of the second part 112 and the third part 115. The first through hole 101 and the second through hole 102 can also make the pressure in the pipe body 140 uniform even when no fluid passes through the pipe body 140.

In a preferred embodiment, in the fluid sensing device, as shown in FIG. 1, the third part 115 is a cylindrical shape, the fourth part 116 being gradually increased in diameter toward the third part 115 to be equal in diameter to the third part 115, that is, the fourth part 116 is a conical shape, the third part 115 and the fourth part 116 being disposed coaxially with the second part 112, respectively.

In the above solution, the fourth part 116 can be caused to sequentially pass through the first through hole 101, the interior of the base 100 and the second through hole 102 when the fluid sensing device is assembled.

In a preferred embodiment, in the fluid sensing device, as shown in FIG. 1, the side wall of the fourth part 116 is provided with a protrusion 117, and the protrusion 117 is arranged so that the protrusion 117 abuts against the base 100 when no fluid enters the pipe body 140 or the third part 115 is located in the base 100, a notch 118 being provided on the fourth part 116 along the axial direction of the fourth part 116, and running through the fourth part 116 and extending into the third part 115, the notch 118 being provided so that the fourth part 116 and the protrusion 117 can both pass through the second through hole 102 when the notch 118 is tightened.

In the above solution, when no fluid enters the pipe body 140 or the spring returns, the protrusion 117 abuts against the base 100 to prevent that larger spring force pushes the piston core rod 110 to the outside of the base 100 when the spring is returned. When assembling the fluid sensing device, when the fourth part 116 sequentially passes through the first through hole 101, the inner part of the base 100 and the second through hole 102, the fourth part 116 is pinched to tighten the notch 118, and the protrusion 117 can pass through the second through hole 102 and abut against the base 100.

In a preferred embodiment, in the fluid sensing device, the base 100 has two bottom surfaces parallel to each other, the base 100 being seamlessly connected or in clearance fit with the inner wall of the pipe body 140 through the side wall of the base, the first through hole 101 and the second through hole 102 being respectively located on two bottom surfaces of the base 100, the bottom surface of the base 100 provided with the second through hole 102 being provided with at least one third opening 103, and the interior of the base 100 being communicated with the downstream end of the pipe body along the fluid flow direction in the pipe body 140 through the third opening 103 in addition to passing through the second through hole 102.

In the above solution, because the base 100 is seamlessly connected with or clearance fit with the inner wall of the pipe body 140 through its side wall such that the driving force for the piston core rod 110 is larger when the fluid in the upstream end of the pipe body 140 along the fluid flow direction therein is flowing. The piston core rod 110 can be easily moved even if flow velocity of the fluid is small.

In a preferred embodiment, in the fluid sensing device, the specific manner that the base 100 is fixed on the pipe body 140 is as follows.

The upstream end and the downstream end of the pipe body 140 along the fluid flow direction therein are both internally hollow cylindrical shape and arranged coaxially, the inner diameter of the upstream end of the pipe body 140 along the fluid flow direction therein being greater than the inner diameter of the downstream end of the pipe body along the fluid flow direction therein, the base 100 being stuck on the upstream end of the pipe body 140 along the fluid flow direction therein, and being seamlessly connected with the upstream end of the pipe body 140 along the fluid flow direction therein, and the bottom surface of the base 100 provided with the second through hole 102 being placed on the downstream end of the pipe body 140 along the fluid flow direction therein, the downstream end of the pipe body 140 along the fluid flow direction therein doing not seal the third opening 103.

In the above solution, the base 100 is placed on the downstream end of the pipe body 140 along the fluid flow direction therein so that the base 100 can be easily inserted into the pipe body 140 along the upstream end of the pipe body 140 along the fluid flow direction therein even if the base 100 can not move along the fluid when the fluid in the pipe body 140 flows.

In a preferred embodiment, in the fluid sensing device, the second opening 114 and the third opening 103 are equal in number and are multiple in number, and multiple second openings 114 being spaced apart along the circumferential direction of the second part 112, when the second opening 114 is located in the base 100, the second opening 114 and the third opening 103 being relative one by one.

In the above solution, when the fluid in the pipe body 140 flows, the fluid can push the piston core rod 110 to move, so that the second opening 114 enters the base 100 and communicates the upstream end of the pipe body 140 along the fluid flow direction therein to the interior of the base 100. The fluid flowing into the interior of the base 100 flows out through each of the third openings 103. Because the second opening 114 is opposite to the third opening 103 one by one, the fluid flowing out of the second opening 114 can quickly flow out of the base 100 through the third opening 103.

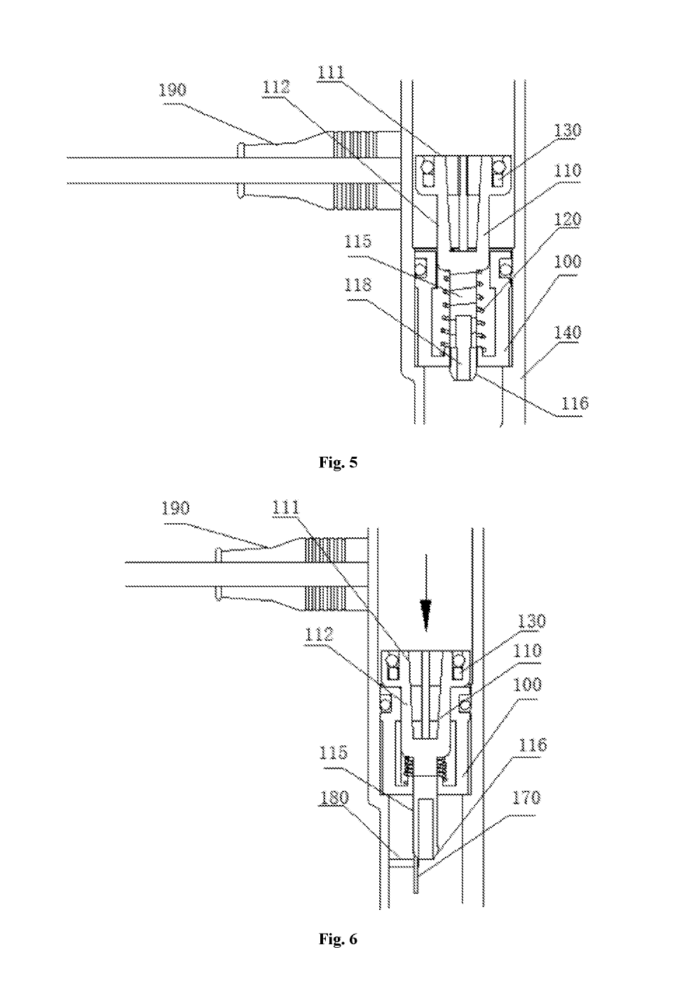

In a preferred embodiment, in the fluid sensing device, as shown in FIG. 2 and FIG. 5, the base 100 comprises an integral upper part and a lower part, the upper part and the lower part of the base 100 being both internally hollow cylindrical and being communicated with each other and coaxially arranged with the pipe body 140, the first through hole 101 being arranged on a bottom surface of the upper part of the base 100, the second through hole 102 being provided on a bottom surface of the lower part of the base 100, the second part 112 and the third part 115 each having an outer diameter smaller than the inner diameter of the upper part and the lower part of the base 100, the outer side wall of the lower part of the base 100 being not in contact with the inner wall of the pipe body 140, The inner diameter of the downstream end of the pipe body 140 along the fluid flow direction therein being smaller than the outer diameter of the lower part of the base 100 and larger than the inner diameter of the lower part of the base 100, so that the lower part of the pipe body 140 can placed on the downstream end of the pipe body 140 along the fluid flow direction therein, a plurality of fourth openings 104 being arranged alternately at the side wall of the lower part of the base 100 in the circumferential direction, the numbers of the fourth opening 104 and the third opening 103 being equal and corresponding one to one, the third openings 103 being arranged alternately along the edge of a bottom surface of the lower part of the base, fourth openings 104 penetrating through the side wall of the lower part of the base and communicating with the corresponding third openings 103, and the plurality of fourth openings 104 being arranged such that the second openings 114 are opposite to the fourth openings 104 one by one when the second openings 114 are located in the base 100, and the base 100 through the upper part thereof being hermetically connected with the upstream end of the pipe body 140 along the fluid flow direction therein. For example, an annular groove is provided on the upper part of the base 100, and an opening of the groove faces the inner wall of the pipe body, an annular sealing ring being disposed in the groove, and an upper part of the base 100 being seamlessly connected to the pipe body 140 by the sealing ring.

In the above solution, when the fluid in the pipe body 140 flows, the fluid can push the piston core rod 110 to move, so that the second opening 114 enters the base 100, the upstream end of the pipe body 140 along the fluid flow direction therein communicates with the inside of the base 100 through the second openings 114, and the fluid flowing into the interior of the base 100 can directly flow out through the third openings 103 or through the fourth openings 104 and then flow out through the third openings 103. The weight of the base 100 can be reduced by providing the fourth opening 104, and the processing cost of the base 100 can be reduced.

In a preferred embodiment, in the fluid sensing device, the magnet 130 is embedded and sealed on the piston core rod 110.

In the above solution, the magnet 130 is embedded and sealed on the piston core rod 110 to save space and avoid the direct contact between the magnet 130 and the fluid. Thus, the problem of the certification and expense caused by the magnet 130 over water is solved.

In a preferred embodiment, in the fluid sensing device, the second opening 114 is elongated shape and runs through the side wall of the second part 112 along the length or the axial direction of the second part 112. When the fluid is not in the pipe body 140, the bottom of the second part 112 is located on the first through hole 101.

In the above solution, when the flow velocity of the fluid in the pipe body 140 is small, the pressure in the upstream end of the pipe body 140 along the fluid flow direction therein increases and is greater than the pressure of the base 100 the downstream end of the pipe body 140 along the fluid flow direction therein. The first through hole 101 can not transmit the pressure of the upstream end of the pipe body 140 along the fluid flow direction therein to the base 100 and the downstream end of the pipe body 140 along the fluid flow direction therein, therefore, the pressure difference will be produced. When the pressure difference is greater than the elastic force of the elastic member 120, the fluid pushes the piston core rod 110 to move so that the second part 112 passes through the first through hole 101, because the second opening 114 approaches the first through hole 101, so that the second opening 114 more easily enters the base 100. In this way, when the flow velocity of the fluid is small, the piston core rod 110 can also move, and the fluid can smoothly flow in the pipe body 140.

In a preferred embodiment, in the fluid sensing device, as shown in FIG. 2 and FIG. 4, the base 100 is provided with a pressure relief hole 105 or a pressure relief groove, and the pressure relief hole 105 or the pressure relief groove is respectively communicated with the upstream end of the pipe body 140 along the fluid flow direction therein and the inside of the base 100.

In the above solution, when the gap between the second part 112 and the first through hole 101 is small, the upstream end of the pipe body 140 along the fluid flow direction therein may be further communicated with the interior of the base 100 through the pressure relief hole 105. When the spring is returned, the fluid in the upstream end of the pipe body 140 along the fluid flow direction therein can flow into the base 100 through the pressure relief hole 105 and then flow out through the downstream end of the pipe body 140 along the fluid flow direction therein.

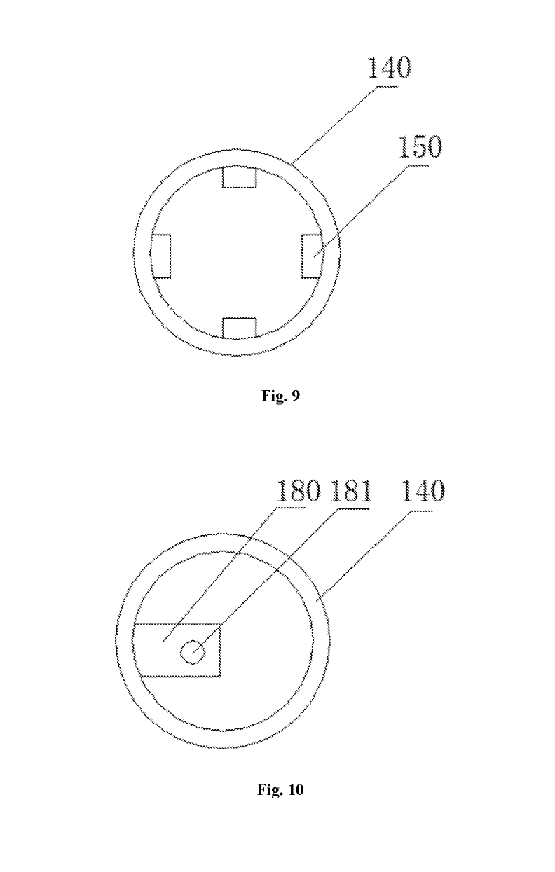

In a preferred embodiment, in the fluid sensing device, as shown in FIG. 8 and FIG. 9, the specific manner that the base 100 is fixed on the pipe body 140 is as follows.

The pipe body 140 and the base 100 are both internally hollow cylindrical shape and arranged coaxially, a gap being arranged between the outer side wall of the base 100 and the inner side wall of the pipe body 140, a plurality of supporting blocks 150 being alternately arranged on the inner side wall of the pipe body 140 along the circumferential direction, the bottom surface of the base 100 provided with the second through holes 102 is laid on plurality of supporting blocks 150, supporting blocks 150 doing not seal the third opening 103, the inner side wall of the pipe body 140 and the outer side wall of the base 100 being alternately provided with a plurality of connecting rods 160 in the circumferential direction of the base 100, one end of each connecting rod 160 being fixedly connected with the inner side of the pipe body 140, and the other end abutting against the outer side wall of the base 100.

In the above solution, the base 100 is placed on the plurality of supporting blocks 150, so that the base 100 can be easily inserted and fixed in the pipe body 140. Because there is a gap between the outer side wall of the base 100 and the inner side wall of the pipe body 140, when there is no fluid in the pipe body 140, the upstream end of the pipe body 140 along the fluid flow direction therein and the downstream end of the pipe body 140 along the fluid flow direction therein can be communicated. When the fluid in the pipe body 140 flows, only a small amount of fluid can flow directly from the gap between the outer side wall of the base 100 and the inner side wall of the pipe body 140, so that when the flow velocity of the fluid is small, the piston core rod 110 can also move.

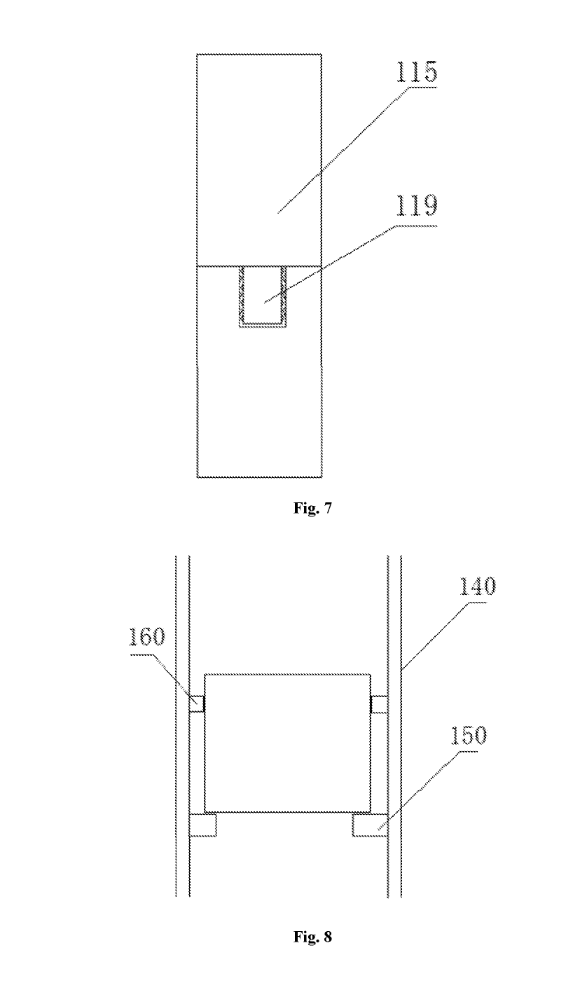

In a preferred embodiment, in the fluid sensing device, as shown in FIG. 7, the third part 115 is composed of two cylinder-shaped rod bodies, the middle part of one of the two rod bodies protruding with a cylinder-shaped connecting part 119, and the middle part of the other of the two rod bodies concaving with a circular hole channel, the connecting part 119 being inserted in the circular hole channel, the connecting part 119 being provided with an external thread, and an internal thread being formed on an inner side wall of the piston core rod 110 forming the hole channel, the connecting part 119 and the inner wall of the circular hole channel formed on the piston core rod 110 being threaded connection.

As shown in FIG. 6 and FIG. 10, the fluid sensing device also comprises: a vertical rod 170 fixed on the side wall of the fourth part 116 and parallel to the axis of the fourth part 116, the vertical rod 170 capable of passing through the second through hole 102 when the notch 118 is tightened; a support rod 180 which is arranged in the downstream end of the pipe body 140 along the fluid flow direction therein and is fixedly connected with the inner side wall of the pipe body 140, the support rod 180 being provided with a third through hole 181, the vertical rod 170 passing through the third through hole 181, the first opening 113 being entirely located in the base 100 when the fourth part 116 is laid on the support rod 180.

In the above solution, both ends of the pipe body 140 are respectively provided with a fluid inlet and a fluid outlet, the fluid inlet being in communication with the upstream end of the pipe body 140 along the fluid flow direction therein, the fluid outlet being in communication with the downstream end of the pipe body 140 along the fluid flow direction therein. Since the first part 111 can not pass through the first through hole 101, the piston core rod 110 can only be taken out from the upstream end of the pipe body 140 along the fluid flow direction therein. When the spring is used for a long time and needs to be replaced, the first part 111 is rotated to separate the two rod bodies, and then the first part 111, the second part 112 and the rod body connected with the second part 112 being taken out from the upstream end of the pipe body 140 along the fluid flow direction therein, and then removing the spring, and then the new spring being sleeved on the rod body connected to the fourth part 116, and then the rod body connected to the second part 112 being inserted into the base 100 and the spring being sleeved on the rod body connected with the second part 112, finally rotating the first part 111 to fix the two rod bodies together. This avoids the problem of simultaneously removing the base 100 and the piston core rod 110 and then fixing the base 100 in the pipe body 140. When replacing the spring, the piston core rod 110 is arranged in the vertical direction. When the two rod bodies are separated, the rod body connected with the fourth part 116 will be placed on the support rod 180. Because the vertical rod 170 is always installed in the third through hole 181, the third through hole 181 can also play a guiding role. When the two rod bodies are separated, the third through hole can limit the rotation of the rod body connected with the fourth part 116. When the spring is replaced, the two rod bodies are fixed together, the piston core rod 110 moving up to the protrusion 117 and abutting against the base 100 under the spring force of the spring.

Although the embodiments of the present invention have been disclosed above, they are not limited to the applications previously mentioned in the specification and embodiments, and can be applied in various fields suitable for the present invention. For ordinary skilled person in the field, other various changed model, formula and parameter may be easily achieved without creative work according to instruction of the present invention, changed, modified and replaced embodiments without departing the general concept defined by the claims and their equivalent are still included in the present invention. The present invention is not limited to particular details and illustrations shown and described herein.

What is claimed is:

1. A fluid sensing device provided in a flow path through which fluid flows, comprising:
a base fixed in the flow path;
a piston core rod disposed in the base and connected to the base through an elastic member, the piston core rod being provided with a pushing surface pushed by the fluid in the flow path;
a magnet provided on the piston core rod; and
a magnetic sensing device provided on a side surface of the piston core rod to sense a change of magnetic line received as a change of a position of the magnet, thereby determining whether the fluid flows in the flow path;
wherein the elastic member is disposed such that a direction of a restoring force of the elastic member is opposite to a flow direction of the fluid in the flow path.

2. The fluid sensing device according to claim 1, further comprising:
a pipe body which is fixed on the flow path along the flow direction of the fluid in the flow path, the pipe body being provided with a passage through which the fluid in the flow path flows, the base and the piston core rod being both located in the pipe body, the base being fixed on the pipe body and being fixed in the flow path by the pipe body, and the magnetic sensing device being arranged on an outer wall of the pipe body.

3. The fluid sensing device according to claim 2, wherein an inner part of the base is hollow and communicated with a downstream end of the pipe body along a flow direction of the fluid in the pipe body, the base is provided with a first through hole, the elastic member is located inside the base, the elastic member is arranged to be compressed along the flow direction of the fluid in the pipe body, the piston core rod is disposed along the flow direction of the fluid in the pipe body and a upstream end of the piston core rod along the flow direction of the fluid in the pipe body passes through the first through hole and is located outside the base, inside the base, the piston core rod is connected to the base through a downstream end of the piston core rod along the flow direction of the fluid in the pipe body by the elastic member, the pushing surface is located on the upstream end of the piston core rod along the flow direction of the fluid in the pipe body, and the upstream end of the piston core rod along the flow direction of the fluid in the pipe body is composed of a first part which can not pass through the first through hole and a second part which can pass through the first through hole along the flow direction of the fluid in the pipe body, and is in clearance fit with the first through hole.

4. The fluid sensing device according to claim 3, wherein the first part and the second part are in a cylindrical shape and arranged coaxially, the first part is in clearance fit with the pipe body, both an inside of the first part and an inside of the second part are hollow and communicating with each other, at least one first opening is disposed on a bottom surface of the first part away from the second part, each of the first openings communicating with an interior of the first part, at least one second opening is disposed at a side wall of the second part, each of the second openings communicating with an interior of the second part, the second opening is configured such that the second opening being entirely located in the base when the first part moves along the flow direction of the fluid in the pipe body to abut the base, and the interior of the second part communicating with an interior of the base through the second opening.

5. The fluid sensing device according to claim 4, wherein a second through hole is arranged on the base, the downstream end of the piston core rod along the flow direction of the fluid in the pipe body passes through the second through hole, and is composed of a third part and a fourth part, the third part is located in the base, a cross-sectional dimension of the third part is less than a cross-sectional dimension of the second part, the fourth part passes through the second through hole and is located outside the base, the second through hole is disposed so that the second through hole is in clearance fit with the third part when the piston core rod moves along the flow direction of the fluid in the pipe body, the elastic member is a spring, the piston core rod in the inner part of the base through the third part being connected with the base by the spring, the spring is sleeved on the third part, and two ends of the spring abut against the base and the second part, respectively.

6. The fluid sensing device according to claim 5, wherein the third part is in a cylindrical shape, the fourth part is gradually increased in diameter toward the third part to be equal in diameter to the third part, and the third part and the fourth part being disposed coaxially with the second part, respectively.

7. The fluid sensing device according to claim 6, wherein a side wall of the fourth part is provided with a protrusion, and the protrusion is arranged so that the protrusion abuts against the base when the third part is located in the base, a notch is provided on the fourth part along a axial direction of the fourth part, and running through the fourth part and extending into the third part, and the notch is provided so that the fourth part and the protrusion can both pass through the second through hole when the notch is tightened.

8. The fluid sensing device according to claim 5, wherein the base has two bottom surfaces parallel to each other, the base is seamlessly connected or in clearance fit with an inner wall of the pipe body through a side wall of the base, the first through hole and the second through hole are respectively located on two bottom surfaces of the base, the bottom surface of the base provided with the second through hole is provided with at least one third opening, and the interior of the base is communicated with the downstream end of the pipe body along the flow direction of the fluid in the pipe body through the third opening.

9. The fluid sensing device according to claim 8, wherein specific manner that the base is fixed on the pipe body is as follows:
an upstream end and the downstream end of the pipe body along the flow direction of the fluid in the pipe body are both in an internally hollow cylindrical shape and arranged coaxially, the inner diameter of the upstream end of the pipe body along the flow direction of the fluid in the pipe body is greater than the inner diameter of the downstream end of the pipe body along the flow direction of the fluid in the pipe body, the base is stuck on the upstream end of the pipe body along the flow direction of the fluid in the pipe body, and is seamlessly connected with the upstream end of the pipe body along the flow direction of the fluid in the pipe body, the bottom surface of the base provided with the second through hole is provided on the downstream end of the pipe body along the flow direction of the fluid in the pipe body, and the downstream end of the pipe body along the fluid flow direction therein does not seal the third opening.

10. The fluid sensing device according to claim 9, wherein the second opening and the third opening are equal in number and are multiple in number, the second openings is spaced apart along the circumferential direction of the second part, and the second opening and the third opening are relative one by one when the second opening is located in the base.

11. The fluid sensing device according to claim 9, wherein the base comprises an integral upper part and a lower part, the upper part and the lower part of the base are both internally hollow cylindrical and being communicated with each other and coaxially arranged with the pipe body, the first through hole is arranged on a bottom surface of the upper part of the base, the second through hole is provided on a bottom surface of the lower part of the base, each of the second part and the third part has an outer diameter smaller than the inner diameter of the upper part and the lower part of the base, an outer side wall of the lower part of the base is not in contact with the inner wall of the pipe body, the inner diameter of the downstream end of the pipe body along the flow direction of the fluid in the pipe body is smaller than the outer diameter of the lower part of the base and larger than the inner diameter of the lower part of the base, a plurality of fourth openings is arranged alternately at the side wall of the lower part of the base in the circumferential direction, the numbers of the fourth opening and the third opening are equal and corresponding one to one, the third openings is arranged alternately along an edge of a bottom surface of the lower part of the base, fourth openings penetrate through the side wall of the lower part of the base and communicate with the corresponding third openings, the plurality of fourth openings is arranged such that the second openings are opposite to the fourth openings one by one when the second openings are located in the base, and the base through the upper part of the base is hermetically connected with the upstream end of the pipe body along the flow direction of the fluid in the pipe body.

12. The fluid sensing device according to claim 1, wherein the magnet is embedded and sealed on the piston core rod.

13. The fluid sensing device according to claim 10, wherein the second opening is in an elongated shape and runs through the side wall of the second part along a length of the second part.

14. The fluid sensing device according to claim 3, wherein the base is provided with a pressure relief hole which is respectively communicated with the upstream end of the pipe body along the flow direction of the fluid in the pipe body and the inside of the base.

15. The fluid sensing device according to claim 8, wherein specific manner that the base is fixed on the pipe body is as follows:
the pipe body and the base are both in an internally hollow cylindrical shape and arranged coaxially, a gap is arranged between the outer side wall of the base and the inner side wall of the pipe body, a plurality of supporting blocks is alternately arranged on the inner side wall of the pipe body along the circumferential direction, the bottom surface of the base provided with the second through hole is laid on a plurality of supporting blocks, the plurality of supporting blocks does not seal the third opening, the inner side wall of the pipe body and the outer side wall of the base being alternately provided with a plurality of connecting rods in the circumferential direction of the base, one end of each of the connecting rods is fixedly connected with the inner side of the pipe body, and the other end abutting against the outer side wall of the base.

16. The fluid sensing device according to claim 7, wherein the third part is composed of two rod bodies, a middle part of one of the two rod bodies protrudes with a cylinder-shaped connecting part, a middle part of the other of the two rod bodies concaves with a circular hole channel, the connecting part is inserted in the circular hole channel, the connecting part and the inner wall of the circular hole channel formed on the piston core rod are in a threaded connection; and
the fluid sensing device further comprises:
a vertical rod fixed on the side wall of the fourth part and parallel to the axis of the fourth part, the vertical rod capable of passing through the second through hole when the notch is tightened; and
a support rod which is arranged in the downstream end of the pipe body along the flow direction of the fluid in the pipe body and fixedly connected with the inner side wall of the pipe body, the support rod being provided with a third through hole, the vertical rod passing through the third through hole, the first opening being entirely located in the base when the fourth part is laid on the support rod.
